(19) United States
(12) Patent Application Publication
(10) Pub. No.: US 2024/0168818 A1
(43) Pub. Date: May 23, 2024

(54) COMPUTING TASK DISPATCHING METHOD, TERMINAL ELECTRONIC DEVICE AND COMPUTING SYSTEM USING THE SAME

(71) Applicant: INDUSTRIAL TECHNOLOGY RESEARCH INSTITUTE, Hsinchu (TW)

(72) Inventors: Chen-Chia HSU, Taoyuan City (TW); Che-Wei SUNG, Tainan City (TW); Chien-Chang CHEN, New Taipei City (TW)

(73) Assignee: INDUSTRIAL TECHNOLOGY RESEARCH INSTITUTE, Hsinchu (TW)

(21) Appl. No.: 18/085,899

(22) Filed: Dec. 21, 2022

(30) Foreign Application Priority Data
Nov. 22, 2022 (TW) 111144584

(51) Int. Cl. G06F 9/50; G06F 9/48

(52) U.S. Cl. CPC G06F 9/505; G06F 9/4881; G06F 9/5016

(57) ABSTRACT

A computing task dispatching method, a terminal electronic device and a computing system using the same are provided. The computing task dispatching method includes the following steps. At least one terminal electronic device monitors a terminal hardware resource usage information of a plurality of sub-tasks. According to the terminal hardware resource usage information, a work dispatching decision is determined to dispatch the sub-tasks to the terminal electronic device or an edge server. The work dispatching decision is used to increase or maximize a utilization rate of the terminal electronic device. The work dispatching decisions is executed.

This application claims the benefit of Taiwan application Serial No. 111144584, filed Nov. 22, 2022, the disclosure of which is incorporated by reference herein in its entirety.

### TECHNICAL FIELD

The disclosure relates in general to a computing task dispatching method, a terminal electronic device and a computing system using the same.

### BACKGROUND

The edge computing architecture is a kind of distributed computing architecture, which sets up an edge server on the edge cloud closer to the location of the terminal device, provides computing and data storage capabilities, and can achieve strong computing capabilities, low latency and other characteristics. Because of the breakthrough and progress of embedded smart networking technology, it is also one of the common technical means for terminal devices to combine edge computing to solve smart identification calculations.

Combining these multiple heterogeneous terminal devices in the edge computing architecture, in the past, too much reliance was placed on the distributed computing strategy with the edge server as the computing center, and the effectiveness of the terminal devices could not be fully utilized. In addition, due to the diverse styles of terminal devices, manufacturers such as application developers spend most of their time and manpower adjusting the optimal calculation allocation between embedded devices and edge servers when deploying applications to edge computing systems. In order to solve the above problems caused by the difference and change of heterogeneous terminal equipment, more labor costs are used to adjust the computing task dispatch and the performance of the terminal equipment cannot be fully utilized, researchers are working hard to propose a new computing task dispatching technology for edge computing.

### SUMMARY

The disclosure is directed to a computing task dispatching method, a terminal electronic device and a computing system using the same.

According to one embodiment, a computing task dispatching method is provided. The computing task dispatching method includes the following steps. At least one terminal electronic device monitors a terminal hardware resource usage information of a plurality of sub-tasks. A work dispatching decision is determined to dispatch the sub-tasks to the terminal electronic device or an edge server according to the terminal hardware resource usage information. The work dispatching decision is used to increase or maximize a utilization rate of the terminal electronic device. The work dispatching decision is executed.

According to another embodiment, a terminal electronic device is provided. The terminal electronic device includes a terminal resource monitoring unit, a terminal decision making unit and a terminal decision execution unit. The terminal resource monitoring unit is configured to monitor a terminal hardware resource usage information of a plurality of sub-tasks. The terminal decision making unit is configured to determine a work dispatching decision to dispatch the sub-tasks to the terminal electronic device or an edge server according to the terminal hardware resource usage information. The work dispatching decision is used to increase or maximize a utilization rate of the terminal electronic device. The terminal decision execution unit is configured to execute the work dispatching decision.

According to an alternative embodiment, a computing system is provided. The computing system includes an edge server and at least one terminal electronic device. The terminal electronic device is connected to the edge server. The terminal electronic device includes a terminal resource monitoring unit, a terminal decision making unit and a terminal decision execution unit. The terminal resource monitoring unit is configured to monitor a terminal hardware resource usage information of a plurality of sub-tasks. The terminal decision making unit is configured to determine a work dispatching decision to dispatch the sub-tasks to the terminal electronic device or an edge server according to the terminal hardware resource usage information. The work dispatching decision is used to increase or maximize a utilization rate of the terminal electronic device. The terminal decision execution unit is configured to execute the work dispatching decision.

### BRIEF DESCRIPTION OF THE DRAWINGS

FIG. 1 shows a schematic diagram of a computing system according to an embodiment.

FIG. 2 shows a block diagram of a computing system according to an embodiment.

FIG. 3 shows a flowchart of a computing task dispatching method according to an embodiment.

FIG. 4 illustrates the terminal hardware resource usage information according to an embodiment.

FIG. 5 shows a detailed flowchart of the step S103 according to an embodiment.

FIGS. 6A to 6C illustrate the operation of the step S103.

FIGS. 7A and 7B show an example of the online procedure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

According to some embodiment of the disclosure, a work dispatching decision is automatically generated through several monitoring means of hardware resources, so as to dispatch a plurality of sub-tasks to a terminal electronic device or an edge server, so that the hardware resources of the terminal electronic device can be obtained relatively large or maximized utilization. In addition, during the operation process, the dispatched sub-tasks can be updated in response to the changes in the operating condition(s), so that the hardware resources of the terminal electronic device can be maintained at a large or maximized utilization.

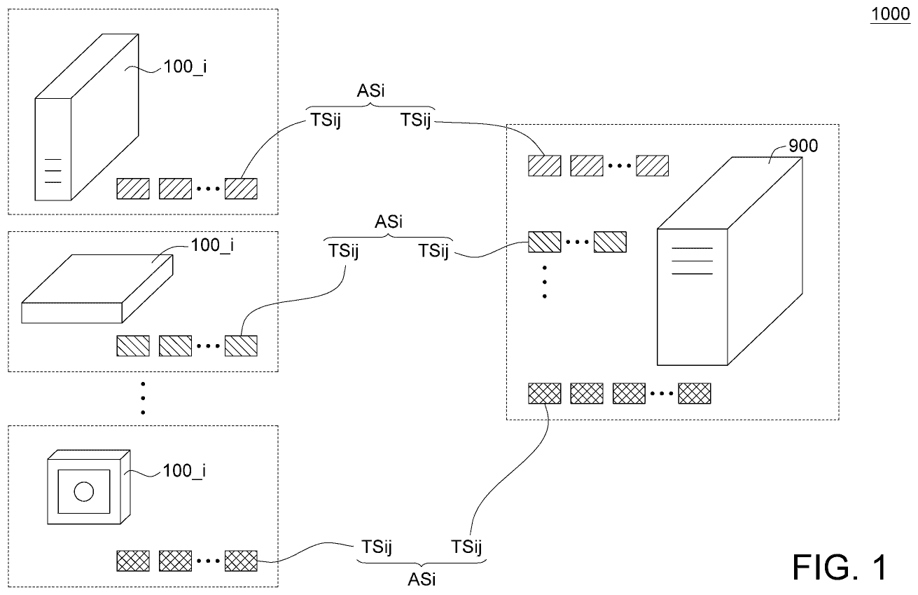

Please refer to FIG. 1, which shows a schematic diagram of a computing system 1000 according to an embodiment. The computing system 1000 includes a plurality of terminal electronic devices 100_i and an edge server 900. Each of the terminal electronic devices 100_i is used to execute one application service ASi. These application services ASi are, for example, the same application service, such as display application (or a route planning application, a self-driving application, etc.) Each of the application services ASi includes a plurality of sub-tasks TSij, such as person recognition, product recognition, touch recognition, etc.

The edge server 900 may be used to execute the application services ASi. In the application service ASi executed by each of the terminal electronic devices 100_i, some of the sub-tasks TSij can be dispatched to the edge server 900 for execution, and some of the sub-tasks TSij may be dispatched to the terminal electronic device 100_i for execution. In one embodiment, the sub-tasks TSij of any terminal electronic device 100_i will not be dispatched to other terminal electronic devices 100_i, but will be dispatched to the edge server 900. The edge server 900 has powerful hardware resources and can assist each of the terminal electronic devices 100_i to execute some of sub-tasks TSij.

The technology is changing rapidly, and various terminal electronic devices 100_i are constantly rolled out, and the hardware resources of the terminal electronic devices 100_i in the computing system 1000 may not be exactly the same. If a fixed dispatching strategy is adopted for these heterogeneous terminal electronic devices 100_i, the performance of the terminal electronic devices 100_i may not be fully utilized. The computing resources of the terminal electronic device 100_i with strong computing capability may be idle.

In one embodiment, the sub-tasks TSij can be automatically dispatched through the monitoring means of hardware resources, so that the utilization of the hardware resources of the terminal electronic devices 100_i can be maximized or increased.

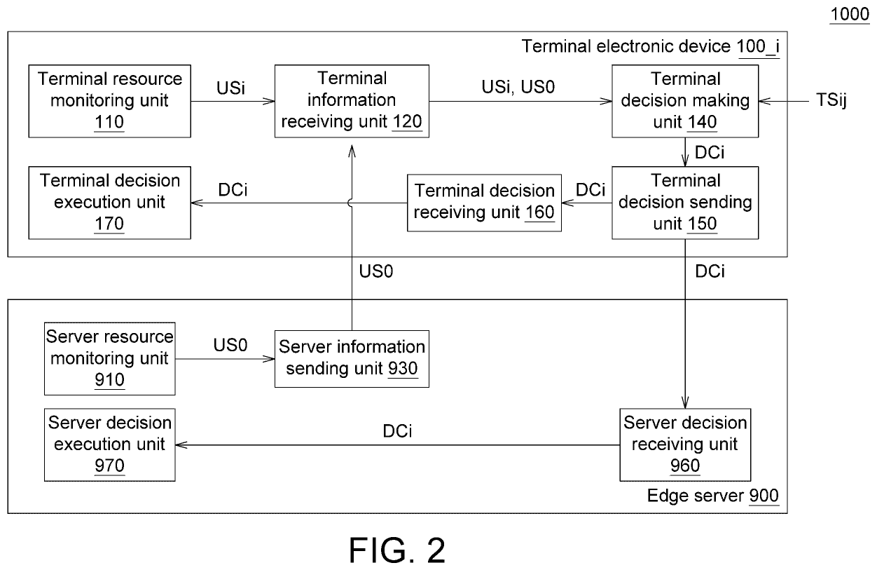

Please refer to FIG. 2, which shows a block diagram of a computing system 1000 according to an embodiment. The terminal electronic device 100_i includes a terminal resource monitoring unit 110, a terminal information receiving unit 120, a terminal decision making unit 140, a terminal decision sending unit 150, a terminal decision receiving unit 160 and/or a terminal decision execution unit 170. In one embodiment, the terminal electronic device 100_i includes, for example, a circuit, a chip, a circuit board, a microcontroller, a microprocessor, a processor, a central processing unit (CPU), a digital signal processor (DSP), an application specific integrated circuit (ASIC), a digital logic circuit, a field programmable gate array (FPGA) and/or the hardware components and/or software with computing and/or processing functions to execute each unit. In one embodiment, the terminal resource monitoring unit 110, the terminal information receiving unit 120, the terminal decision making unit 140, the terminal decision sending unit 150, the terminal decision receiving unit 160, the terminal decision execution unit 170 of the terminal electronic device 100_i, for example, uses hardware and/or software to execute various information sending and receiving procedures, information processing and/or control procedures. In one embodiment, the hardware is, for example, a circuit, a chip, a circuit board, a microcontroller, a microprocessor, a processor, a central processing unit (CPU), a digital signal processor (DSP), an application-specific integrated circuit (ASIC), a digital logic circuit, a field programmable logic gate array (FPGA) and/or other hardware components with computing and/or processing functions. The software is, for example, a computer program product or a storage device for storing program codes. The storage device for storing program codes, for example, can store software programs in non-transitory computer readable storage media, such as a hard drive, a solid state drive, a compact disc, a USB disk or a memory. When the processor loads the software from the non-transitory computer readable storage medium, the method of the present invention can be executed.

The edge server 900 includes a server resource monitoring unit 910, a server information sending unit 930, a server decision receiving unit 960 and a server decision execution unit 970. In one embodiment, the edge server 900 includes, for example, a circuit, a chip, a circuit board, a microcontroller, a microprocessor, a processor, a central processing unit (CPU), a digital signal processor (DSP), an application specific integrated circuit (ASIC), a digital logic circuit, a field programmable gate array (FPGA) and/or the hardware components and/or software with computing and/or processing functions to execute each unit. In one embodiment, the server resource monitoring unit 910, the server information sending unit 930, the server decision receiving unit 960 and the server decision execution unit 970 of the edge server 900, for example, uses hardware and/or software to execute various information sending and receiving procedures, information processing and/or control procedures. In one embodiment, the hardware is, for example, a circuit, a chip, a circuit board, a microcontroller, a microprocessor, a processor, a central processing unit (CPU), a digital signal processor (DSP), an application-specific integrated circuit (ASIC), a digital logic circuit, a field programmable logic gate array (FPGA) and/or other hardware components with computing and/or processing functions. The software is, for example, a computer program product or a storage device for storing program codes. The storage device for storing program codes, for example, can store software programs in non-transitory computer readable storage media, such as a hard drive, a solid state drive, a compact disc, a USB disk or a memory. When the processor loads the software from the non-transitory computer readable storage medium, the method of the present invention can be executed.

The state in which the terminal electronic device 100_i and the edge server 900 are not connected (Data may not be exchanged, for example, terminal electronic device 100_i or the edge server 900 does not connect to the internet) is called an offline state; the state in which the terminal electronic device 100_i and the edge server 900 are connected (Data may be exchanged, for example, terminal electronic device 100_i and the edge server 900 may connect to internet, communicate wirelessly or with wire, physically connect with table, etc.) and/or jointly executes the application service ASi is called an online state.

In this embodiment, when one terminal electronic device 100_i newly joins the computing system 1000, the terminal electronic device 100_i can determine an initial work dispatching decision DCi at the offline state, so as to dispatch these sub-tasks TSij to the terminal electronic device 100_i or the edge server 900, to increase or maximize the utilization rate of the terminal electronic device 100_i.

When entering the online state, the terminal electronic device 100_i will update the work dispatching decision DCi according to the operating condition(s). The following describes the operation of the offline state and the online state with flow chart.

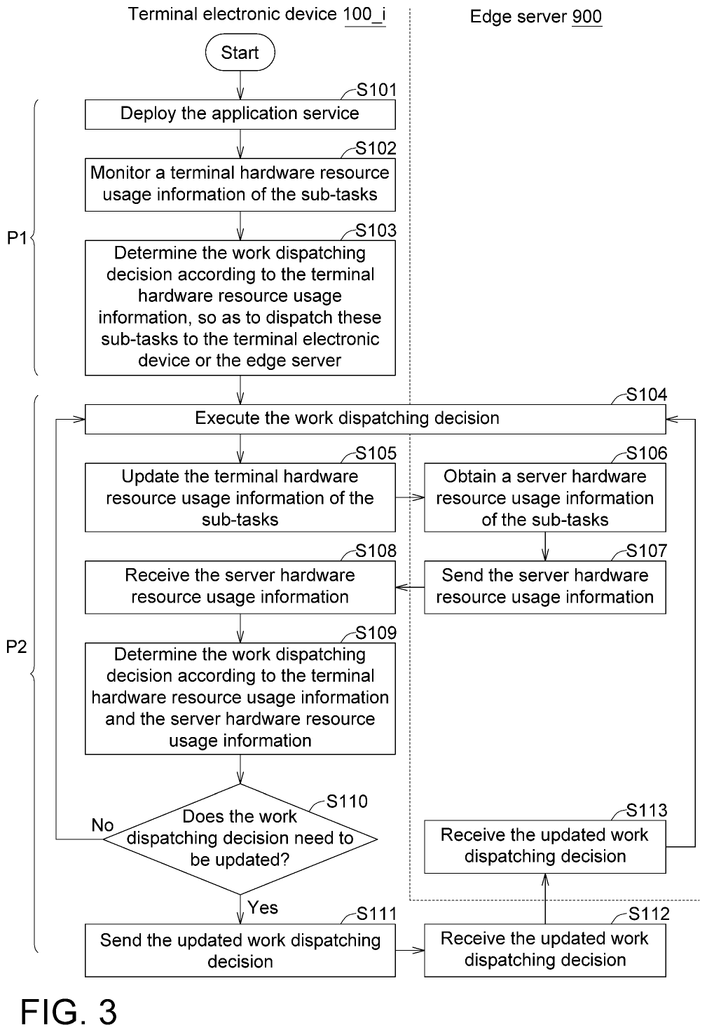

Please refer to FIG. 3, which shows a flowchart of a computing task dispatching method according to an embodiment. The computing task dispatching method includes an offline procedure P1 executed at the offline state and an online procedure P2 executed at the online state. The offline procedure P1 includes steps S101 to S103. In the step S101, the terminal resource monitoring unit 110 deploys the application service ASi on the terminal electronic device 100_i. In this step, the terminal resource monitoring unit 110, for example, arranges all possible sub-tasks TSij of the application service ASi on an execution queue.

Next, in step S102, the terminal resource monitoring unit 110 of the terminal electronic device 100_i monitors a terminal hardware resource usage information USi of the sub-tasks TSij. In this step, each of the sub-tasks TSij, for example, is executed independently in order to know how much terminal hardware resources are needed when executing each of the sub-tasks TSij.

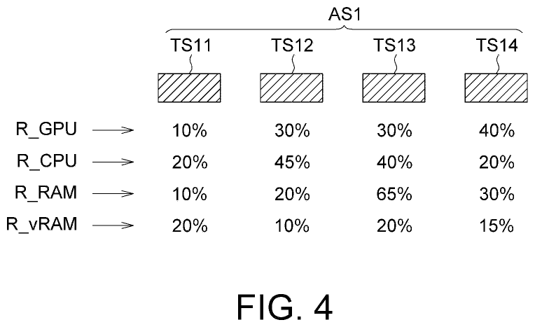

Please refer to FIG. 4, which illustrates the terminal hardware resource usage information USi according to an embodiment. The terminal hardware resource usage information USi includes, for example, a GPU usage R_GPU, a CPU usage R_CPU, a GPU memory usage R_vRAM and/or a RAM usage R_RAM. The application service AS1, for example, includes four sub-tasks TS11 to TS14. When the sub-task TS11 is executed independently on the terminal electronic device 100_i, it occupies 10% of the GPU usage R_GPU, 20% of the CPU usage R_CPU, 10% of the RAM usage R_RAM, and 20% of the GPU memory usage R_vRAM. When the sub-task TS12 is executed independently on the terminal electronic device 100_i, it occupies 30% of the GPU usage R_GPU, 45% of the CPU usage R_CPU, 20% of the RAM usage R_RAM, and 10% of the GPU memory usage R_vRAM. The description of the sub-tasks TS13 and TS14 is similar, so the description will not be repeated.

In one embodiment, if the four sub-tasks TS11 to TS14 are executed simultaneously, the GPU usage R_GPU of the terminal electronic device 100_i will exceed 100%. Therefore, an analysis is required to determine which sub-tasks TS11 to TS14 the terminal electronic device 100_i can execute.

Then, in the step S103, the terminal decision making unit 140 determines the work dispatching decision DCi according to the terminal hardware resource usage information USi, so as to dispatch these sub-tasks TSij to the terminal electronic device 100_i or the edge server 900, for example, either to the terminal electronic device 100_i or to the edge server 900. The work dispatching decision DCi is used to increase or maximize the utilization rate of the terminal electronic device 100_i. As shown in FIG. 2, the terminal information receiving unit 120 receives the terminal hardware resource usage information USi from the terminal resource monitoring unit 110, and forwards it to the terminal decision making unit 140.

In one embodiment, the value of the graphics processor (GPU) is higher than that of the central processing unit (CPU), so it is necessary to give highest or higher priority to the GPU usage R_GPU, then consider the CPU usage R_CPU, and then consider the GPU memory usage R_vRAM and the RAM usage R_RAM, so that the terminal electronic device 100_i be able to make the most effective or more effective use.

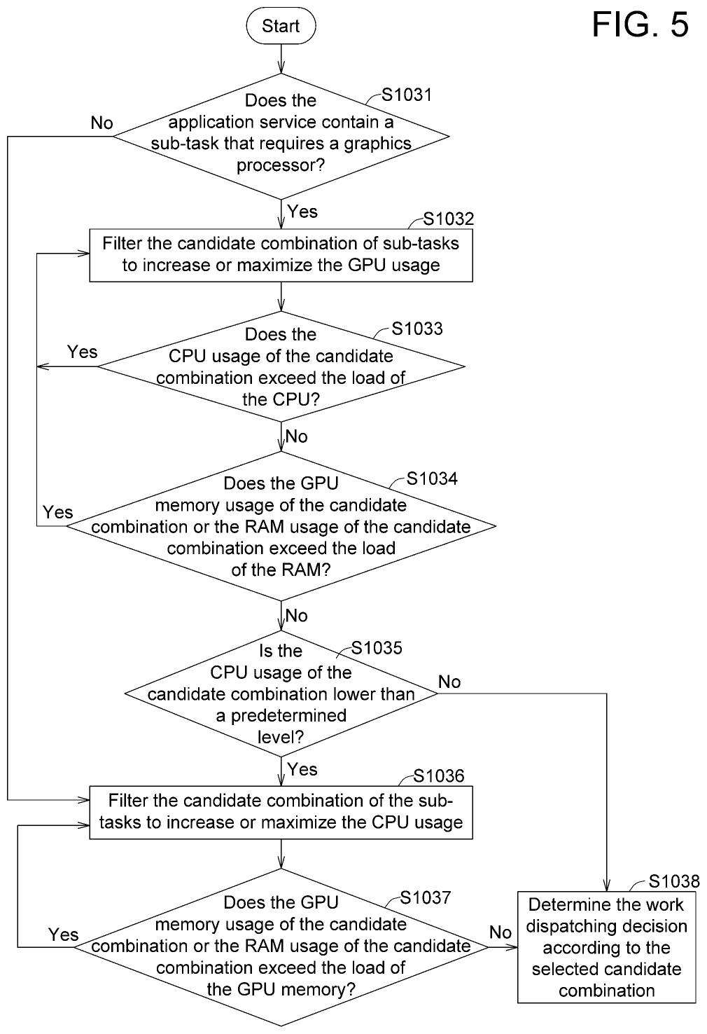

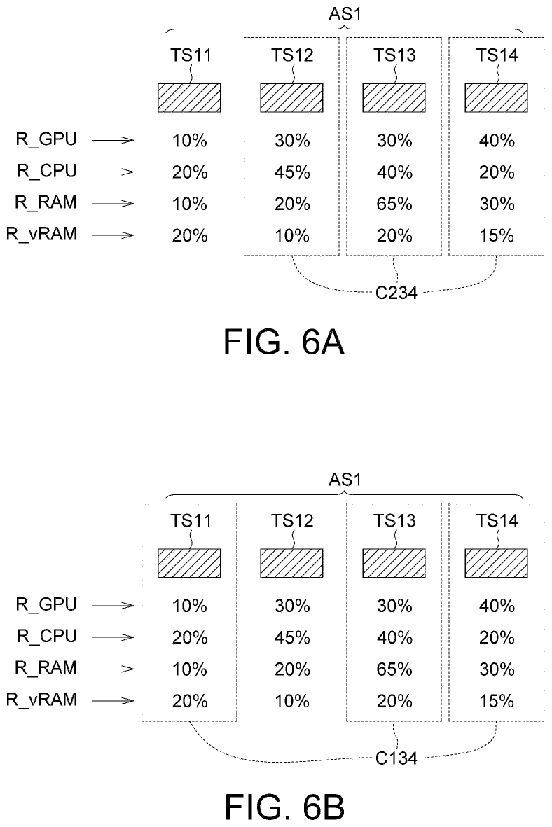

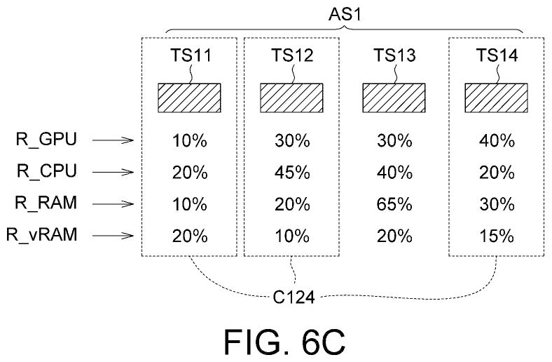

Please refer to FIG. 5 and FIGS. 6A to 6C. FIG. 5 shows a detailed flowchart of the step S103 according to an embodiment, and FIGS. 6A to 6C illustrate the operation of the step S103. The step S103 includes steps S1031 to S1038. In the step S1031, the terminal decision making unit 140 determines whether the application service ASi contains a sub-task TSij that requires a graphics processor. If there is a sub-task TSij that needs the graphics processor, the process proceeds to the step S1032; if there is no sub-task TSij that needs the graphics processor, the process proceeds to the step S1036. Taking FIG. 6A as an example, the application service AS1 contains the sub-tasks TS11 to TS14 that require the graphics processor, so the process proceeds to the step S1032.

In the step S1032, the terminal decision making unit 140 filters the candidate combination of sub-tasks TSij to increase or maximize the GPU usage R_GPU. Taking FIG. 6A and Table I below as an example, there are 16 combinations of the four sub-tasks TSij in total. After excluding a combination of selecting the all four sub-tasks TSij (the GPU usage R_GPU is 110%), from the remaining 15 combinations, the one who maximizes the GPU usage R_GPU is judged first. For increasing or maximizing the GPU usage R_GPU but not exceeding the load, the terminal decision making unit 140 can select the candidate combination C234 of the sub-tasks TS12, TS13, and TS14.

TABLE I

| sub-task | sub-task | sub-task | sub-task | GPU usage |
|---|---|---|---|---|
| TS11 | TS12 | TS13 | TS14 | R_GPU |
| ● | ● | ● | ● | 110 |
| ● | ● | ● | | 70 |
| ● | ● | | ● | 80 |
| ● | | ● | ● | 80 |
| | ● | ● | ● | 100 |
| ● | ● | | | 40 |
| ● | | ● | | 40 |
| ● | | | ● | 50 |
| | ● | ● | | 60 |
| | ● | | ● | 70 |
| | | ● | ● | 70 |
| ● | | | | 10 |
| | ● | | | 30 |
| | | ● | | 30 |
| | | | ● | 40 |
| | | | | 0 |

Then, in the step S1033, the terminal decision making unit 140 determines whether the CPU usage R_CPU of the candidate combination exceeds the load of the CPU. If the CPU usage R_CPU of the candidate combination exceeds the load of the CPU, the process returns to the step S1032; if the CPU usage R_CPU of the candidate combination does not exceed the load of the CPU, the process proceeds to the step S1034. Taking FIG. 6A as an example, the CPU usage R_CPU of the candidate combination C234 has reached 105%, exceeding the load of the CPU, so the process returns to the step S1032.

When returning to the step S1032, after excluding combinations in which the CPU usage R_CPU exceeds the load, the terminal decision making unit 140 will filter the remaining combinations to increase or maximize the GPU usage R_GPU. Taking FIG. 6B and Table I as an example, after excluding the candidate combination C234, the terminal decision making unit 140 may select a candidate combination C134 of the sub-tasks TS11, TS13, TS14.

In the step S1034, the terminal decision making unit 140 determines whether the GPU memory usage R_vRAM of the candidate combination exceeds the load of the GPU memory or the RAM usage R_RAM of the candidate combination exceeds the load of the RAM. If the GPU memory usage R_vRAM of the candidate combination exceeds the load of the GPU memory or the RAM usage R_RAM of the candidate combination exceeds the load of the RAM, the process returns to the step S1032, if the GPU memory usage R_vRAM of the candidate combination does not exceed the load of the GPU memory and the RAM usage R_RAM of the candidate combination does not exceed the load of the RAM, then the process proceeds to the step S1035. Taking FIG. 6B as an example, the RAM usage R_RAM of the candidate combination C134 has reached 105%, exceeding the load of the RAM, so the process returns to the step S1032.

When returning to the step S1032, after excluding combinations in which the CPU usage R_CPU exceeds the load, the terminal decision making unit 140 will filter the remaining combinations to increase or maximize the GPU usage R_GPU. Taking FIG. 6C as an example, after excluding the candidate combination C234 and C134, the terminal decision making unit 140 can obtain a candidate combination C124 of the sub-tasks TS11, TS12, TS14.

In the step S1035, the terminal decision making unit 140 determines whether the CPU usage R_CPU of the candidate combination is lower than a predetermined level. If the CPU usage R_CPU of the candidate combination is lower than the predetermined level, then the process proceeds to the step S1036; if the CPU usage R_CPU of the candidate combination is not lower than the predetermined level, then the process proceeds to the step S1038. The predetermined level is, for example, 50%. Taking FIG. 6C as an example, the CPU usage R_CPU of the candidate combination C124 is 80%, which is not lower than the predetermined level, so the process proceeds to the step S1038.

In the step S1036, the terminal decision making unit 140 filters the candidate combination of the sub-tasks TSij to increase or maximize the CPU usage R_CPU.

Then, in the step S1037, the terminal decision making unit 140 determines whether the GPU memory usage R_vRAM of the candidate combination exceeds the load of the GPU memory or the RAM usage R_RAM of the candidate combination exceeds the load of the RAM. If the GPU memory usage R_vRAM the candidate combination exceeds the load of the GPU memory or the RAM usage R_RAM of the candidate combination exceeds the load of the RAM, the process returns to the step S1036; if the GPU memory usage R_vRAM of the candidate combination does not exceed the load of the GPU memory and the RAM usage R_RAM of the candidate combination does not exceed the load of the RAM, then the process proceeds to the step S1038.

Then, in the step S1038, the terminal decision making unit 140 determines the work dispatching decision DCi according to the selected candidate combination. The sub-tasks TSij in the selected candidate combination will be dispatched to the terminal electronic device 100_i for execution, and the rest of the sub-tasks TSij will be dispatched to the edge server 900 for execution.

Through above-mentioned step S1031 to S1038, the work dispatching decision DCi can be determined.

In one embodiment, one work dispatching decision DCi is determined for each of the terminal electronic devices 100_i. Each of the terminal electronic devices 100_i executes the above-mentioned offline procedure P1.

The above steps S101 to S103 are the offline procedure P1. After deciding the work dispatching decision DCi, the process proceeds to step S104 to S113 of the online procedure P2.

Then, in the step S104 in FIG. 3, the terminal electronic device 100_i and the edge server 900 execute the work dispatching decision DCi. In detail, please referring to FIG. 2, after the terminal decision sending unit 150 obtains the work dispatching decision DCi from the terminal decision making unit 140, it sends the work dispatching decision DCi to the terminal decision receiving unit 160 and the server decision receiving unit 960. After the terminal decision execution unit 170 obtains the work dispatching decision DCi from the terminal decision receiving unit 160, it executes some of the sub-tasks TSij according to the work dispatching decision DCi. After the server decision execution unit 970 obtains the work dispatching decision DCi from the server decision receiving unit 960, it executes some of the sub-tasks TSij (for example, the sub-tasks not dispatch to the terminal electronic device) according to the work dispatching decision DCi.

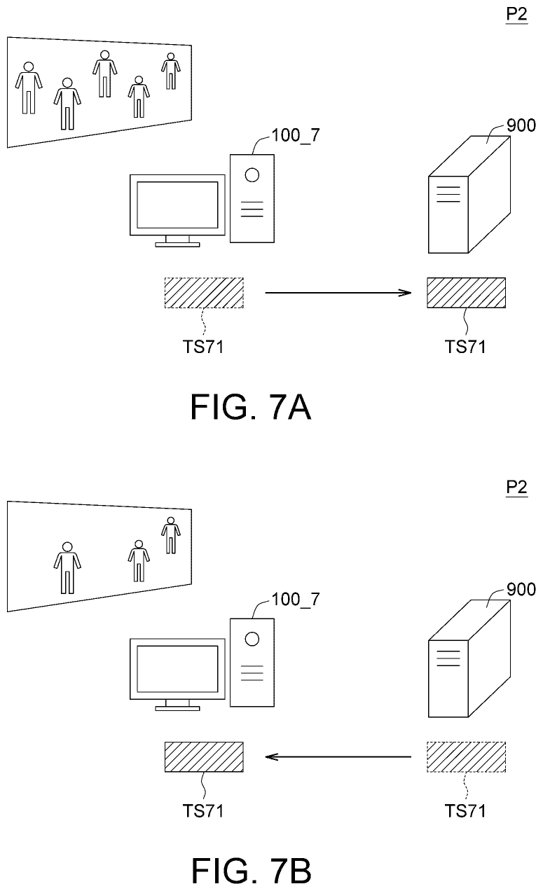

Please refer to FIGS. 7A and 7B, which show an example of the online procedure P2. During the operation of the online procedure P2, the actual operation may change continuously. For example, as shown in FIG. 7A, when the number of customers in the store increases, the facial recognition sub-task TS71 may cause excessive load on the terminal electronic device 100_7, so it may need to move the facial recognition sub-task TS71 to the edge server 900 for execution to avoid the utilization rate of the terminal electronic device from over loading. As shown in FIG. 7B, when the number of customers in the store decreases, the facial recognition sub-task TS71 will not cause excessive load to the terminal electronic device 100_7, so the facial recognition sub-task TS71 can be moved back to the terminal electronic device 100_7 for execution.

In the step S105 in FIG. 3, the terminal resource monitoring unit 110 of the terminal electronic device 100_i updates the terminal hardware resource usage information USi of the sub-tasks TSij. In this step, the terminal resource monitoring unit 110 periodically updates the terminal hardware resource usage information USi of the sub-tasks TSij, and transmits the updated terminal hardware resource usage information USi to the terminal information receiving unit 120.

Then, in the step S106, the server resource monitoring unit 910 of the edge server 900 obtains a server hardware resource usage information US0 of the sub-tasks TSij. In this step, the server resource monitoring unit 910 periodically updates the server hardware resource usage information US0 of the sub-tasks TSij, and sends the updated server hardware resource usage information US0 to the server information sending unit 930.

Then, in the step S107, the server information sending unit 930 sends the server hardware resource usage information US0 to the terminal electronic device 100_i.

Next, in the step S108, the terminal information receiving unit 120 of the terminal electronic device 100_i receives the server hardware resource usage information US0. As shown in FIG. 2, the terminal information receiving unit 120 receives the terminal hardware resource usage information USi and the server hardware resource usage information US0, and forwards the terminal hardware resource usage information USi and the server hardware resource usage information US0 to the terminal decision making unit 140.

Then, in the step S109, the terminal decision making unit 140 determines the work dispatching decision DCi according to the terminal hardware resource usage information USi and the server hardware resource usage information US0. The newly determined work dispatching decision DCi may be the same as or may be different from the original work dispatching decision DCi. In an embodiment, the step S109 and the step S103 may be the same or similar.

In this embodiment, the step S109 of updating the work dispatching decision DCi is executed by the terminal electronic device 100_i, not by the edge server 900. Each of the terminal electronic devices 100_i can generate the best work dispatching decision DCi according to its own situation.

Next, in the step S110, the terminal decision making unit 140 determines whether the work dispatching decision DCi needs to be updated. If the work dispatching decision DCi needs to be updated, then the process proceeds to the step S111, if the work dispatching decision DCi does not need to be updated, then the process proceeds to the step S104.

In the step S111, the terminal decision sending unit 150 sends the updated work dispatching decision DCi.

Then, in the step S112, the terminal decision receiving unit 160 receives the updated work dispatching decision DCi.

Then, in the step S113, the server decision receiving unit 960 receives the updated work dispatching decision DCi.

Then, the process returns to the step S104, the terminal electronic device 100_i and the edge server 900 execute the work dispatching decision DCi. In detail, please refer to FIG. 2, after the terminal decision execution unit 170 obtains the work dispatching decision DCi from the terminal decision receiving unit 160, it executes some of the sub-tasks TSij according to the work dispatching decision DCi. After the server decision execution unit 970 obtains the work dispatching decision DCi from the server decision receiving unit 960, it executes some of the sub-tasks TSij according to the work dispatching decision DCi.

The above steps S104 to S113 are the online procedure P2. The online procedure P2 is periodically repeated to respond to changes in the operating conditions, so that the hardware resources of each of the terminal electronic devices 100_i can be maintained at a large or maximized utilization.

According to the above-mentioned embodiments, the work dispatching decision DCi is automatically generated through the monitoring means of hardware resources, so as to dispatch the sub-tasks TSij to the terminal electronic devices 100_i or the edge server 900, so that the hardware resources of each of the terminal electronic devices 100_i can be obtained relatively large or maximized utilization. In addition, during the operation process, the dispatched sub-tasks TSij can be updated in response to the changes in the operating condition(s), so that the hardware resources of each of the terminal electronic devices 100_i can be maintained at a large or maximized utilization.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A computing task dispatching method, comprising:
monitoring, by at least one terminal electronic device, a terminal hardware resource usage information of a plurality of sub-tasks;
determining a work dispatching decision to dispatch the sub-tasks to the terminal electronic device or an edge server according to the terminal hardware resource usage information, wherein the work dispatching decision is used to increase or maximize a utilization rate of the terminal electronic device; and
executing the work dispatching decision.

2. The computing task dispatching method according to claim 1, wherein the terminal hardware resource usage information includes a plurality of GPU usages corresponding to the sub-tasks and a plurality of CPU usages corresponding to the sub-tasks; and in the step of determining the work dispatching decision, a combination of some of the sub-tasks is obtained by way of increasing or maximizing the GPU usages and then by way of increasing or maximizing the CPU usages.

3. The computing task dispatching method according to claim 2, wherein the terminal hardware resource usage information further includes a plurality of GPU memory usages corresponding to the sub-tasks and a plurality of RAM usages corresponding the sub-tasks; and in the step of determining the work dispatching decision, a combination of some of the sub-tasks is obtained by way of increasing or maximizing the CPU usages and then by way of increasing or maximizing the GPU memory usages and by way of increasing or maximizing the RAM usages.

4. The computing task dispatching method according to claim 1, further comprising:
updating, by the terminal electronic device, the terminal hardware resource usage information of the sub-tasks;
determining, by the edge server, a server hardware resource usage information of the sub-tasks;
updating the work dispatching decision according to the terminal hardware resource usage information and the server hardware resource usage information; and
executing the work dispatching decision which is updated.

5. The computing task dispatching method according to claim 4, wherein the step of updating the work dispatching decision is executed by the terminal electronic device.

6. The computing task dispatching method according to claim 4, wherein in the step of updating the work dispatching decision, some of the sub-tasks are moved from the edge server to the terminal electronic device to increase or maximize the utilization rate of the terminal electronic device.

7. The computing task dispatching method according to claim 4, wherein in the step of updating the work dispatching decision, some of the sub-tasks are moved from the terminal electronic device to the edge server to avoid the utilization rate of the terminal electronic device from over loading.

8. A terminal electronic device, comprising:
a terminal resource monitoring unit, configured to monitor a terminal hardware resource usage information of a plurality of sub-tasks;
a terminal decision making unit, configured to determine a work dispatching decision to dispatch the sub-tasks to the terminal electronic device or an edge server according to the terminal hardware resource usage information, wherein the work dispatching decision is used to increase or maximize a utilization rate of the terminal electronic device; and
a terminal decision execution unit, configured to execute the work dispatching decision.

9. The terminal electronic device according to claim 8, wherein the terminal hardware resource usage information includes a plurality of GPU usages corresponding to the sub-tasks and a plurality of CPU usages corresponding to the sub-tasks; and the terminal decision making unit obtains a combination of some of the sub-tasks by way of increasing or maximizing the GPU usages and then by way of increasing or maximizing the CPU usages, to determine the work dispatching decision.

10. The terminal electronic device according to claim 9, wherein the terminal hardware resource usage information further includes a plurality of GPU memory usages corresponding to the sub-tasks and a plurality of RAM usages corresponding the sub-tasks; and the terminal decision making unit obtains a combination of some of the sub-tasks by way of increasing or maximizing the CPU usages and then by way of increasing or maximizing the GPU memory usages and by way of increasing or maximizing the RAM usages to determine the work dispatching decision.

11. The terminal electronic device according to claim 8, further comprising:
a terminal information receiving unit, configured to obtain a server hardware resource usage information of the sub-tasks from the edge server, wherein the terminal resource monitoring unit updates the terminal hardware resource usage information of the sub-tasks, and the terminal decision making unit updates the work dispatching decision according to the terminal hardware resource usage information and the server hardware resource usage information; and
a terminal decision sending unit, configured to send the work dispatching decision to the terminal decision execution unit and the edge server, to execute the work dispatching decision which is updated.

12. The terminal electronic device according to claim 11, wherein in the work dispatching decision which is updated, some of the sub-tasks are moved from the edge server to the terminal electronic device to increase or maximize the utilization rate of the terminal electronic device.

13. The terminal electronic device according to claim 11, wherein in the work dispatching decision which is updated, some of the sub-tasks are moved from the terminal electronic device to the edge server to avoid the utilization rate of the terminal electronic device from over loading.

14. A computing system, comprising:
an edge server; and
at least one terminal electronic device, connected to the edge server, wherein the terminal electronic device includes:
a terminal resource monitoring unit, configured to monitor a terminal hardware resource usage information of a plurality of sub-tasks;
a terminal decision making unit, configured to determine a work dispatching decision to dispatch the sub-tasks to the terminal electronic device or an edge server according to the terminal hardware resource usage information, wherein the work dispatching decision is used to increase or maximize a utilization rate of the terminal electronic device; and
a terminal decision execution unit, configured to execute the work dispatching decision.

15. The computing system according to claim 14, wherein the terminal hardware resource usage information includes a plurality of GPU usages corresponding to the sub-tasks and a plurality of CPU usages corresponding to the sub-tasks; and the terminal decision making unit obtains a combination of some of the sub-tasks by way of increasing or maximizing the GPU usages and then by way of increasing or maximizing the CPU usages, to determine the work dispatching decision.

16. The computing system according to claim 14, wherein the terminal hardware resource usage information further includes a plurality of GPU memory usages corresponding to the sub-tasks and a plurality of RAM usages corresponding the sub-tasks; and the terminal decision making unit obtains a combination of some of the sub-tasks by way of increasing or maximizing the CPU usages and then by way of increasing or maximizing the GPU memory usages and by way of increasing or maximizing the RAM usages to determine the work dispatching decision.

17. The computing system according to claim 14, wherein the terminal electronic device further includes:
a terminal information receiving unit, configured to obtain a server hardware resource usage information of the sub-tasks from the edge server, wherein the terminal resource monitoring unit updates the terminal hardware resource usage information of the sub-tasks, and the terminal decision making unit updates the work dispatching decision according to the terminal hardware resource usage information and the server hardware resource usage information; and
a terminal decision sending unit, configured to send the work dispatching decision to the terminal decision execution unit and the edge server, to execute the work dispatching decision which is updated.

18. The computing system according to claim 17, wherein the edge server further includes:
a server information sending unit, configured to send the server hardware resource usage information of the sub-tasks.

19. The computing system according to claim 17, wherein in the work dispatching decision which is updated, some of the sub-tasks are moved from the edge server to the terminal electronic device to increase or maximize the utilization rate of the terminal electronic device.

20. The computing system according to claim 17, wherein in the work dispatching decision which is updated, some of the sub-tasks are moved from the terminal electronic device to the edge server to avoid the utilization rate of the terminal electronic device from over loading.
